(19) United States
(12) Patent Application Publication
(10) Pub. No.: US 2016/0084352 A1
(43) Pub. Date: Mar. 24, 2016

(54) POWERSHIFT REVERSING GEARBOX

(71) Applicant: ZF Friedrichshafen AG, Friedrichshafen (DE)

(72) Inventor: Norman REGENSCHEIT, Meckenbeuren (DE)

(21) Appl. No.: 14/860,969

(22) Filed: Sep. 22, 2015

(30) Foreign Application Priority Data
Sep. 23, 2014 (DE) 10 2014 219 106.8

(51) Int. Cl. F16H 3/093; F16H 47/06

(52) U.S. Cl. CPC F16H 3/093; F16H 47/06

(57) ABSTRACT

A powershiftable reversing transmission for a vehicle with a drive engine arranged off-center and a telescopically extendable lifting arm. The reversing transmission has a shaft (4) for forward driving and a shaft (5) for reverse driving, with a clutch (9) for forward driving and a clutch (10) for reverse driving. Two fixed wheels (20, 21) are arranged on the shaft (4) for forward driving, while only one clutch and one fixed wheel are arranged on the other shafts.

This application claims priority from German patent application serial no. 10 2014 219 106.8 filed Sep. 23, 2014.

### FIELD OF THE INVENTION

The invention concerns a powershiftable reversing transmission for a vehicle with a drive engine arranged off-center.

### BACKGROUND OF THE INVENTION

Powershiftable reversing transmissions of this type are used in working machines, such as vehicles with a telescopically extendable arm, so-termed telehandlers or telescopic vehicles. These vehicles often have a telescopic lifting arm arranged centrally in the vehicle, with the drive engine arranged on one side of the vehicle and the driver's cabin on the other side of the telescopic arm.

Since the drive shafts to the front and rear axles of the vehicle often also extend centrally, it is necessary for the drive output of the gearshift transmission to be positioned almost centrally in the longitudinal direction of the vehicle. Because of this the distance between the drive engine and the drive output shafts of the transmission has to be bridged.

DE 10131329 A1 discloses a powershiftable reversing transmission for a vehicle with a drive engine arranged off-center, in which, particularly in FIG. 5 thereof, the drive input shaft of the gearshift transmission, which can be connected to the drive engine, is arranged a distance away from the drive output shaft of the gearshift transmission, whereby it is made possible for the drive output shaft to be arranged almost centrally in the vehicle, whereas the drive input shaft is arranged to one side in the area of the drive engine. Owing to the direct flange connection of the transmission to the drive engine, a great deal of fitting space in the vehicle's longitudinal direction is needed, which has to be provided by the lateral arrangement between the vehicle's wheels; in vehicles with a short wheel base, however, this is not possible.

U.S. Pat. No. 6,152,253 discloses a drive unit for a vehicle with a drive engine arranged off-center and a lifting arm arranged centrally in the vehicle, wherein the drive engine and the transmission are arranged close to but a distance away from one another, the drive output shaft of the drive engine and the drive input shaft of the transmission are located on the same side, and the distance is bridged by a chain transmission. Although this arrangement is suitable also for vehicles with a short wheel base, the lifting arm has to be positioned at a very high level so as not to collide with the transmission housing, and this considerably restricts the vision from the driver's cabin.

### SUMMARY OF THE INVENTION

The purpose of the present invention is to provide a powershiftable reversing transmission for a vehicle with an drive engine arranged off-center and a centrally arranged lifting arm, which is suitable for vehicles with a short wheel base and which has no restrictive effect on the driver's vision from the driver's cabin.

This objective is achieved with a powershiftable reversing transmission of the type in question which also embodies the characterizing features as described below.

The invention is based on the recognition that a drive system with a drive engine, for example an internal combustion engine, arranged off-center, is only possible in a vehicle with a short wheel base if the drive output shaft of the drive engine and the drive input shaft of the powershiftable reversing transmission extend in the same direction and the drive engine and powershiftable reversing transmission are arranged close to but a distance away from, i.e. parallel to one another. The drive output shaft of the drive engine and the drive input shaft of the powershiftable reversing transmission can be connected by a connecting gear assembly, for example a spur gear assembly or a chain transmission. The main drive output shaft of the powershiftable reversing transmission should be designed such that the main drive output shaft of the powershiftable reversing transmission coincides with the front axle of the vehicle, i.e. the axle arranged near the free end of the lifting mast, since the front axle is the main drive output axle. The drive engine and the powershiftable reversing transmission should be arranged so that the drive output shaft of the drive engine and the drive input shaft of the powershiftable reversing transmission extend in the direction of the free end of the lifting mast and thus toward the front of the vehicle. In this way the part of the powershiftable reversing transmission having the largest diameter, namely the outer diameter of the housing that surrounds the hydrodynamic torque converter, is displaced toward the front end of the vehicle, thus creating more fitting space for a hydraulic cylinder that actuates the lifting arm and is arranged in the rear portion of the vehicle. To position the lifting arm even lower and thereby improve the driver's vision, the powershiftable reversing transmission must be moved even closer to the drive engine and the drive output shaft of the powershiftable reversing transmission must be a distance away from the drive input shaft of the powershiftable reversing transmission, whereby the drive output shaft is positioned almost centrally in the vehicle and the drive input shaft of the powershiftable reversing transmission is displaced laterally toward the drive engine. In that way the highest point of the housing surrounding the hydrodynamic torque converter is arranged outside the lifting arm.

This is possible because the powershiftable reversing transmission comprises a drive input shaft and a drive output shaft that are arranged a distance away from one another and the distance is bridged by gearwheels on gearshift shafts and shafts for forward and reverse driving. In this case only one clutch is arranged on each shaft and, except for the shaft for forward driving, all the shafts have only one fixed wheel. In that the shaft for forward driving has two fixed wheels, the main drive output shaft on the transmission can be arranged on the same side as the drive input shaft and the front axle of the vehicle can be driven with the correct rotational direction for the drive output shaft. In addition, when the forward driving direction is engaged the drive unit has the best efficiency, since there are then fewer meshing gearwheel pairs.

In a further design version of the invention, an additional drive output shaft can be arranged on the powershiftable reversing transmission, which can be connected to the rear axle of the vehicle, this additional drive output shaft being arranged either coaxially with the drive output shaft for the front axle, or by virtue of an additional spur gear stage at a distance away from the drive output shaft for the front axle. The additional drive output shaft for the rear axle can be driven permanently, or it can be disconnected by a clutch. When the drive output shaft is coaxial it can be connected to the main drive output shaft.

Since only one clutch is arranged on the shafts, a powershiftable reversing transmission which is short in the axial direction is obtained, which bridges the distance between the drive input shaft and the drive output shaft of the powershiftable reversing transmission. Since both the clutch for forward driving and two fixed wheels are arranged on the shaft for forward driving, the drive output shaft for the front axle can be positioned on the same side as the drive input shaft in the powershiftable reversing transmission. In particular, a reversing transmission that can be fitted into a restricted space is obtained.

Since during forward driving the drive unit can be realized with a small number of meshing gearwheels, the efficiency can be increased and gearing losses reduced.

### BRIEF DESCRIPTION OF THE DRAWINGS

Further characteristics emerge from the descriptions of the figures.

These show:

FIG. 1: A schematic representation of the powershiftable reversing transmission;

FIG. 2: A spatial arrangement of the gearwheels and shafts of the powershiftable reversing transmission;

FIG. 3: A spatial arrangement of the gearwheels and shafts of the powershiftable reversing transmission;

FIG. 4: A spatial arrangement of the gearwheels and shafts of the powershiftable reversing transmission;

FIG. 5: An arrangement of the powershiftable reversing transmission in the vehicle; and

FIG. 6: A schematic representation of a cross-section through the vehicle.

### DETAILED DESCRIPTION OF THE PREFERRED EMBODIMENTS

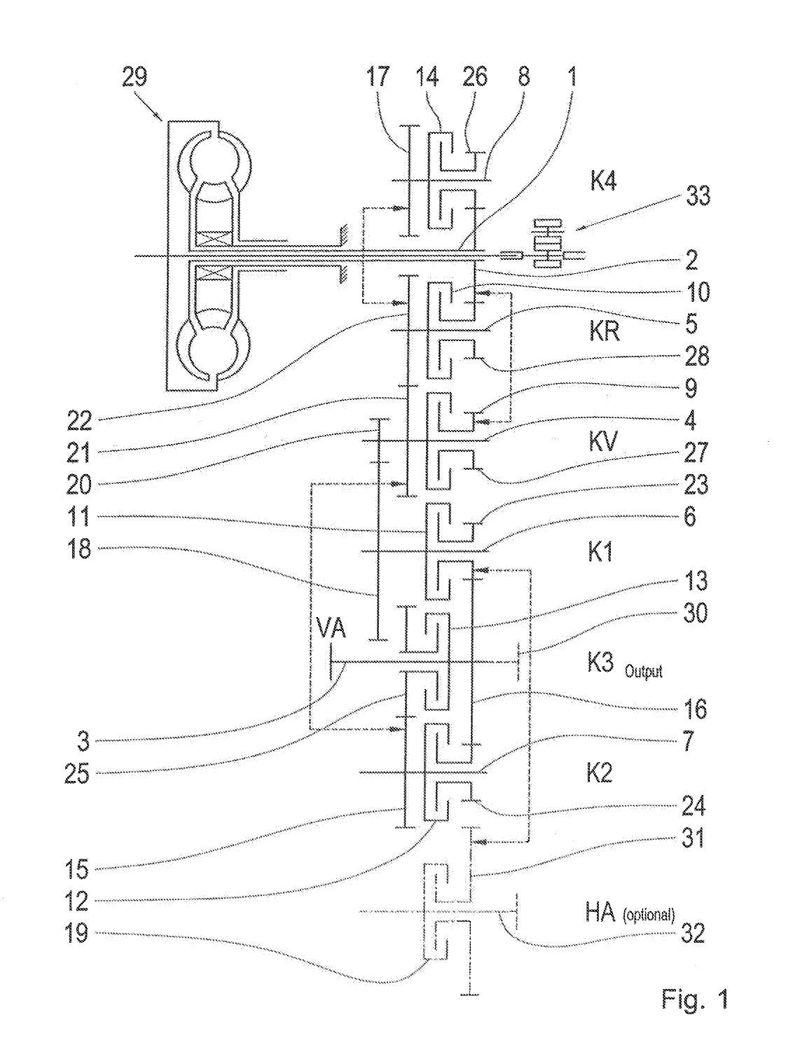

### FIG. 1

A drive input shaft 1 of the powershiftable reversing transmission can be driven by means of a hydrodynamic torque converter 29, and a first fixed wheel 2 is connected rotationally fixed to the drive input shaft 1. A fixed wheel is understood to mean a gearwheel connected to a shaft in a rotationally fixed manner. A loose wheel is understood to mean a gearwheel arranged on and able to rotate about a fixed shaft or a shaft rotating at a different rotational speed. A fourth loose wheel 26, a fifth loose wheel 27 and a sixth loose wheel 28 are in permanent functional engagement with the first fixed wheel 2. The fourth loose wheel 26 is mounted to rotate about the third gearshift shaft 8, the fifth loose wheel 27 is mounted to rotate about the shaft 4 for forward driving and the sixth loose wheel 28 is mounted to rotate about the shaft 5 for reverse driving. The shaft 5 for reverse driving is connected in a rotationally fixed manner to a ninth fixed wheel 22, which is in permanent functional engagement with the fourth fixed wheel 17 and with the eighth fixed wheel 21. The fourth fixed wheel 17 is connected rotationally fixed to the third gearshift shaft 8. The eighth fixed wheel 21 is connected rotationally fixed to the shaft 4 for forward driving. The seventh fixed wheel 20 is connected rotationally fixed to the shaft 4 for forward driving, and is in permanent functional engagement with the fifth fixed wheel 18, which is connected rotationally fixed to the first gearshift shaft 6. The eighth fixed wheel 21 is in permanent functional engagement with the second fixed wheel 15, which is connected rotationally fixed to the second gearshift shaft 7. The second loose wheel 24 is mounted to rotate about the second gearshift shaft 7 and is in permanent functional engagement with the third fixed wheel 16, which is connected rotationally fixed to the drive output shaft 3. The drive output shaft 3 can be connected to a front axle of the vehicle. The drive output shaft 3 and the drive input shaft 1 are arranged on the same side of the powershiftable reversing transmission. A further drive output shaft 30 can be connected directly to the drive output shaft 3 in a rotationally fixed manner, but a clutch can also be arranged between the further drive output shaft 30 and the drive output shaft 3. The further drive output shaft 30 can be connected to a rear axle of the vehicle. It is also possible to bring the loose wheel 31 into engagement with the first loose wheel 23 and to connect a further drive output shaft 32 by way of a rear axle clutch 19 to the loose wheel. When the clutch 9 for forward driving is actuated in the closing direction, the fifth loose wheel 27 is connected in a rotationally fixed manner to the shaft 4 for forward driving and thus also to the seventh fixed wheel 20 and the eighth fixed wheel 21. If the clutch 10 for reverse driving is actuated in the closing direction, the sixth loose wheel 28 is connected rotationally fixed to the shaft 5 for reverse driving and to the ninth fixed wheel 22. When the first gearshift clutch 11 is actuated in the closing direction, the first loose wheel 23 is connected rotationally fixed to the first gearshift shaft 6 and to the fifth fixed wheel 18. When the second gearshift clutch 12 is actuated in the closing direction, the second loose wheel 24 is connected rotationally fixed to the second gearshift shaft 7 and to the second fixed wheel 15. If the third gearshift clutch 13 is actuated in the closing direction, the third loose wheel 25 is connected rotationally fixed to the drive output shaft 3 and to the third fixed wheel 16. When the fourth gearshift clutch 14 is actuated in the closing direction, the fourth loose wheel 26 is connected rotationally fixed to the third gearshift shaft 8 and to the fourth fixed wheel 17. Since the structure of the transmission is very narrow, an auxiliary power take-off 33 can be arranged on the reversing transmission, which is connected in a rotationally fixed manner to the input shaft in the converter. By appropriate actuation of the clutch 9 for forward driving, the clutch 10 for reverse driving, the first gearshift clutch 11, the second gearshift clutch 12, the third gearshift clutch 13 and the fourth gearshift clutch 14, four gears in the forward direction and four gears in the reverse direction can be engaged.

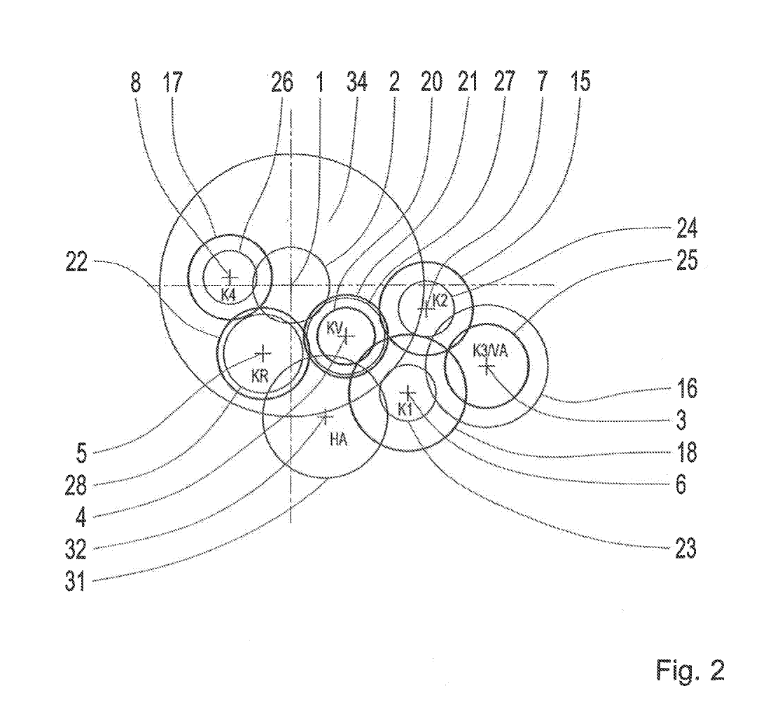

### FIG. 2

The drive input shaft 1, the third gearshift shaft 8, the shaft 5 for reverse driving and the shaft 4 for forward driving are accommodated within the external radial dimensions of the housing 34 of the hydrodynamic torque converter. The drive output shaft 3, the third fixed wheel 16 and the third loose wheel 26 are arranged outside the radial extension of the housing 34 of the hydrodynamic torque converter, whereby an axial distance can be realized between the drive input shaft 1 and the drive output shaft 3. The shaft 5 for reverse driving, the shaft 4 for forward driving, the second gearshift shaft 7, the drive output shaft 3, the first gearshift shaft 6 and the further drive output shaft 32 are positioned below a plane 43 that extends horizontally in the vehicle, parallel to the ground on which the vehicle is standing and through the rotational axis of the drive input shaft 1, whereas the third gearshift shaft 8 is arranged above that plane 43.

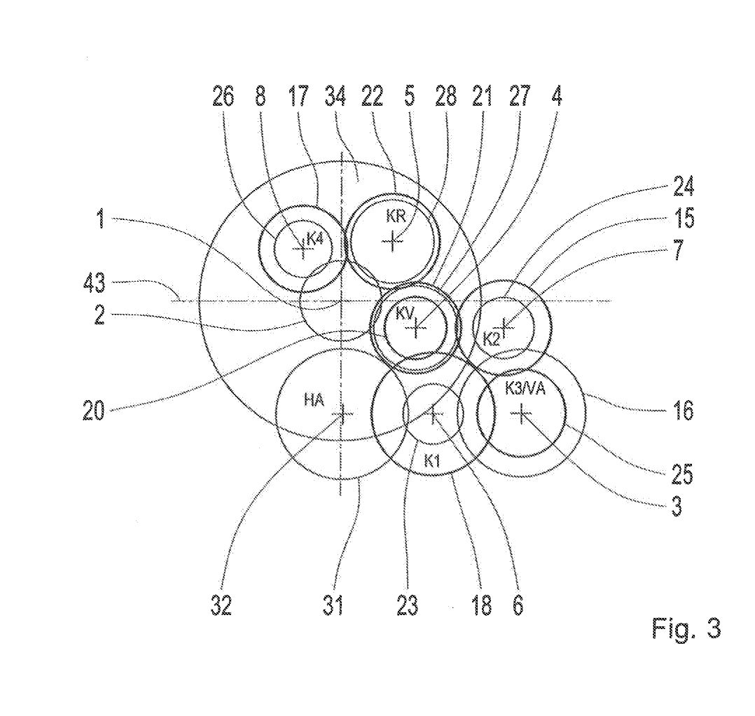

### FIG. 3

The drive input shaft 1, the third gearshift shaft 8, the shaft 5 for reverse driving, the shaft 4 for forward driving and the further drive output shaft 32 are arranged within a radial extension of a housing 34 of the hydrodynamic torque converter, while the first gearshift shaft 6, the second gearshift shaft 7 and the drive output shaft 3 are arranged outside this radial extension of the housing 34 of the hydrodynamic torque converter. The shaft 4 for forward driving, the second gearshift shaft 7, the first gearshift shaft 6 and the drive output shaft 3 are positioned below a plane 43 that passes through the rotational axis of the drive input shaft 1, whereas the third gearshift shaft 8 and the shaft 5 for reverse driving are above the plane 43. Since the drive output shaft 3 is a distance away from the drive input shaft 1, the lifting arm and its hydraulic cylinder can be positioned outside the housing 34 of the hydrodynamic torque converter, above the second fixed wheel 15. In that way the lifting arm can be positioned lower down, which results in clearer vision in the vehicle.

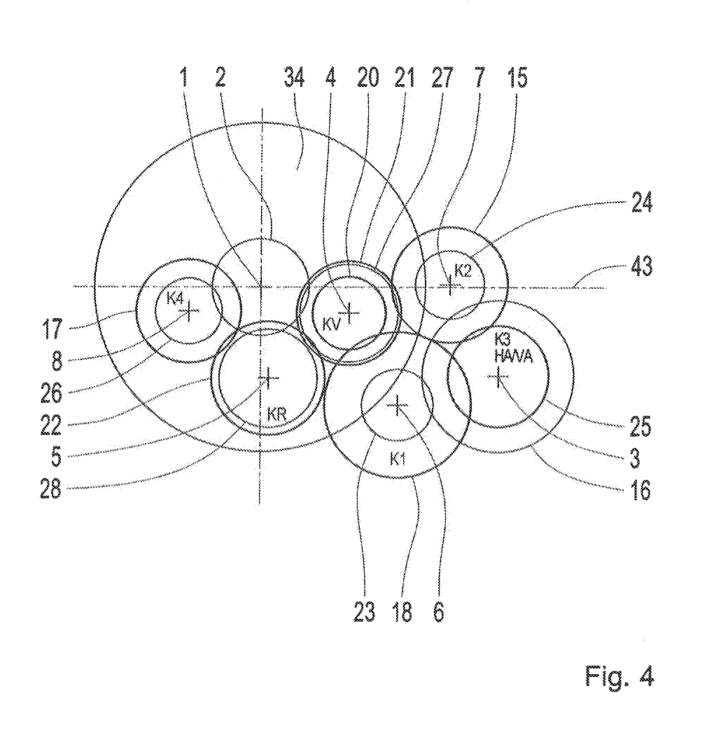

### FIG. 4

The drive input shaft 1, the third gearshift shaft 8, the shaft 5 for reverse driving and the shaft 4 for forward driving are arranged within the radial extension of the housing 34 of the hydrodynamic torque converter. The first gearshift shaft 6, the drive output shaft 3 and the second gearshift shaft 7 are arranged outside the housing 34. The third gearshift shaft 8, the shaft 5 for reverse driving, the shaft 4 for forward driving, the first gearshift shaft 6 and the drive output shaft 3 are arranged below a plane 43 passing through the rotational axis of the drive input shaft 1. The second gearshift shaft 7 is arranged above the plane 43.

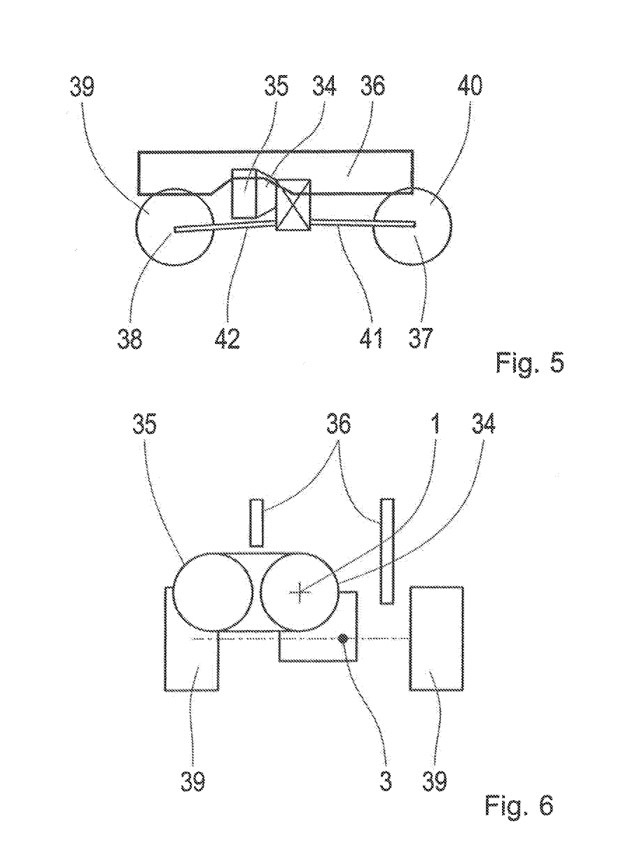

### FIG. 5

The housing 34 of the hydrodynamic torque converter is connected, on the one hand, to a spur gear assembly 35 and, on the other hand, to the powershiftable reversing transmission. The drive output of the powershiftable reversing transmission is connected, on the one hand to a cardan shaft 42 for the front axle 38 and a cardan shaft 41 for the rear axle 37. On the front axle 38 are arranged wheels 40 and on the rear axle 37 there are also wheels 40. The vehicle has a frame 36.

### FIG. 6

The frame 36 is recessed on one side so that the spur gear assembly 35 can connect the drive output of a drive engine (not shown) to the drive input of the powershiftable reversing transmission. The drive output shaft 3 of the powershiftable reversing transmission is arranged approximately centrally in order to drive the wheels 40 by way of a cardan shaft. The drive input shaft 1 of the powershiftable reversing transmission is both horizontally and vertically at a distance away from the drive output shaft 3, whereby some fitting space is created above the powershiftable reversing transmission, in particular laterally, on the housing 34 of the hydrodynamic torque converter, in which space, the lifting arm or the lifting cylinder can be accommodated. The lifting cylinder of the vehicle is, on the one hand, articulated in the direction of the rear axle 37 on the vehicle frame 36 and, on the other hand, in the direction of the front axle 38 on the lifting arm. Since the components having the largest diameter, such as the housing 34 of the hydrodynamic torque converter, are arranged displaced toward the front axle 38, the vehicle has more fitting space for the lifting cylinder.

### INDEXES

1 Drive input shaft
2 First fixed wheel
3 Drive output shaft
4 Shaft for forward driving
5 Shaft for reverse driving
6 First gearshift shaft
7 Second gearshift shaft
8 Third gearshift shaft
9 Clutch for forward driving
10 Clutch for reverse driving
11 First gearshift clutch
12 Second gearshift clutch
13 Third gearshift clutch
14 Fourth gearshift clutch
15 Second fixed wheel
16 Third fixed wheel
17 Fourth fixed wheel
18 Fifth fixed wheel
19 Rear axle clutch
20 Seventh fixed wheel
21 Eighth fixed wheel
22 ninth fixed wheel
23 First loose wheel
24 Second loose wheel
25 Third loose wheel
26 Fourth loose wheel
27 Fifth loose wheel
28 Sixth loose wheel
29 Torque converter
30 Further drive output shaft
31 Loose wheel
32 Further drive output shaft
33 Auxiliary power take-off
34 Housing of the hydrodynamic torque converter
35 Spur gear assembly
36 Frame
37 Rear axle
38 Front axle
39 Wheels
40 Wheels
41 Cardan shaft
42 Cardan shaft
43 Plane

1-8. (canceled)

9. A powershiftable reversing transmission for a vehicle with a drive engine arranged off-center, the reversing transmission comprising:
a drive input shaft (1) and gearwheels in a form of fixed wheels (2, 15, 16, 17, 18, 20, 21, 22) which are connected, in a rotationally fixed manner, to respective shafts (1, 3, 4, 5, 6, 8) and gearwheels in a form of loose wheels (23, 24, 25, 26, 27, 28, 31) which are mounted for rotation on respective shafts (3, 4, 5, 6, 7, 8)
a first fixed wheel (2) being connected, in a rotationally fixed manner, to the drive input shaft (1), and at least six rotary shafts (3, 4, 5, 6, 7, 8) which are connectable, in each case, by a respective clutch (9, 10, 11, 12, 13, 14) to a respective loose wheel (23, 24, 25, 26, 27, 28),
one of the six rotary shafts is a drive output shaft (3), another one of the six rotary shafts is a shaft (4) for forward driving, a further one of the six rotary shafts is a shaft (5) for reverse driving, and a remaining three rotary shafts, of the six rotary shafts (6, 7, 8), are gearshift shafts,
a forward clutch (9) is a clutch for forward driving, a reverse clutch (10) is a clutch for reverse driving and first, second, third and four gearshift clutches (11, 12, 13, 14) are gearshift clutches, the forward clutch (9) for forward driving cooperating with the shaft (4) for forward driving, and the reverse clutch (10) for reverse driving cooperating with the shaft (5) for reverse driving,
only one of the forward clutch, the reverse clutch, the first gearshift clutch, the second gearshift clutch, the third gearshift clutch and the fourth gearshift clutch (9. 10, 11, 12, 13, 14) being arranged on each of the six rotary shafts, the first fixed wheel (2) being in permanent functional connection with a loose wheel (28), for reverse driving, a loose wheel (27), for forward driving, and a loose wheel (26) that is connectable with the fourth gearshift clutch (14),
wherein the rotary shaft (4), for forward driving, cooperates with the forward clutch (9) for forward driving, is connected in a rotationally fixed manner to two of the fixed wheels (20, 21), while each the other five shafts (3, 5, 6, 7, 8) is respectively connected just one fixed wheel (2, 15, 16, 17, 18, 22).

10. The powershiftable reversing transmission according to claim 9, wherein one fixed wheel (20), of two fixed wheels (20, 21), engages with a fixed wheel (18) which is connected in a rotationally fixed manner to a first gearshift shaft (6) of the three gearshift shafts (6, 7, 8) and is connectable, by the first gearshift clutch (11), to a first loose wheel (23), and the first loose wheel (23) cooperates with a fixed wheel (16) that is connected in a rotationally fixed manner to the drive input shaft (3).

11. The powershiftable reversing transmission according to claim 9, wherein one fixed wheel (21), of two fixed wheels (20, 21), engages with a fixed wheel (22) that is connected in a rotationally fixed manner to the shaft (5) for reverse driving.

12. The powershiftable reversing transmission according to claim 9, wherein only one gearshift shaft (8) is arranged above a horizontal plane (43) that passes through a rotational axis of the drive input shaft (1), when the powershiftable reversing transmission is fitted in a vehicle, and the other shafts (3, 4, 5, 6, 7) of the reversing transmission are positioned either on or below the plane (43).

13. The powershiftable reversing transmission according to claim 9, wherein the drive input shaft (1) is connected to a hydrodynamic torque converter which has a housing (34), and only one gearshift shaft (8) is arranged inside the housing (34) while the other gearshift shafts are arranged radially outside the housing (34).

14. The powershiftable reversing transmission according to claim 9, wherein the reversing transmission has a first housing side and a second housing side, on an opposite side thereof, such that the drive input shaft (1), for connection to a torque converter, and the drive output shaft (3), for connection to a cardan shaft for connection to a front axle, are positioned on the first housing side.

15. The powershiftable reversing transmission according to claim 14, wherein a further drive output shaft (32), for connection to another cardan shaft for connection to a rear axle, is positioned on the second housing side.

16. A mobile vehicle in combination with a powershiftable reversing transmission, a drive engine, which is positioned off-center, and a centrally positioned lifting arm, the powershiftable reversing transmission comprising:
a drive input shaft (1) and gearwheels in a form of fixed wheels (2, 16, 17, 18, 20, 21, 22) which are connected, in a rotationally fixed manner, to respective shafts (1, 3, 4, 5, 6, 8) and gearwheels in a form of loose wheels (23, 24, 25, 26, 27, 28, 31) which are mounted for rotation on respective shafts (3, 4, 5, 6, 7, 8)
a first fixed wheel (2) being connected, in a rotationally fixed manner, to the drive input shaft (1), and at least six rotary shafts (3, 4, 5, 6, 7, 8) which are connectable, in each case, by a respective clutch (9, 10, 11, 12, 13, 14) to a respective loose wheel (23, 24, 25, 26, 27, 28),
one of the six rotary shafts is a drive output shaft (3), another one of the six rotary shafts is a shaft (4) for forward driving, a further one of the six rotary shafts is a shaft (5) for reverse driving, and a remaining three rotary shafts, of the six rotary shafts (6, 7, 8), are gearshift shafts,
a forward clutch (9) is a clutch for forward driving, a reverse clutch (10) is a clutch for reverse driving and first, second, third and four gearshift clutches (11, 12, 13, 14) are gearshift clutches, the forward clutch (9) for forward driving cooperating with the shaft (4) for forward driving, and the reverse clutch (10) for reverse driving cooperating with the shaft (5) for reverse driving,
only one of the forward clutch, the reverse clutch, the first gearshift clutch, the second gearshift clutch, the third gearshift clutch and the fourth gearshift clutch (9, 10, 11, 12, 13, 14) being arranged on each of the six rotary shafts, the first fixed wheel (2) being in permanent functional connection with a loose wheel (28), for reverse driving, a loose wheel (27), for forward driving, and a loose wheel (26) that is connectable with the fourth gearshift clutch (14),
wherein the rotary shaft (4), for forward driving, cooperates with the forward clutch (9) for forward driving, is connected in a rotationally fixed manner to two of the fixed wheels (20, 21), while each the other five shafts (3, 5, 6, 7, 8) is respectively connected just one fixed wheel (2, 15, 16, 17, 18, 22), and
a drive output of the drive engine is connected by way of a spur gear assembly (35) to the drive input shaft (1) of the reversing transmission in such manner that the drive engine and the reversing transmission are arranged on one side of the spur gear assembly (35).
